(19) United States
(12) Patent Application Publication
(10) Pub. No.: US 2026/0214682 A1
(43) Pub. Date: Jul. 23, 2026

(54) METHOD AND DEVICE FOR SIDELINK COMMUNICATION, TERMINAL, AND STORAGE MEDIUM

(71) Applicant: Beijing Xiaomi Mobile Software Co., Ltd., Beijing (CN)

(72) Inventor: Xiaowei JIANG, Beijing (CN)

(73) Assignee: Beijing Xiaomi Mobile Software Co., Ltd., Beijing (CN)

(21) Appl. No.: 19/141,515

(22) PCT Filed: Dec. 20, 2022
(86) PCT No.: PCT/CN2022/140502

§ 371 Date: Jun. 20, 2025

(51) Int. Cl. H04W 72/25; H04B 7/06; H04W 24/10

(52) U.S. Cl. CPC H04W 72/25; H04B 7/0626; H04W 24/10

(57) ABSTRACT

A method for sidelink (SL) communication is provided. The method is performed by a terminal and includes: determining whether a listen-before-talk (LBT) fails for an SL transmission unit transmitted by the terminal; and managing, in a case where the SL transmission unit includes a report, the report based on a determination result.

### CROSS-REFERENCE TO RELATED APPLICATION

The present application is a U.S. National Stage of International Application No. PCT/CN2022/140502, filed on Dec. 20, 2022, the contents of all of which are incorporated herein by reference in their entirety for all purposes.

### BACKGROUND OF THE INVENTION

In a communication system, direct communication between terminals is achieved by introducing sidelink (SL). SL communication between the terminals may be achieved by transmitting an SL transmission unit. The SL transmission unit may be transmitted on at least one of an SL grant configured by a network device or an SL grant autonomously selected by the terminals.

### SUMMARY OF THE INVENTION

The present disclosure relates to the technical field of communication, and particularly relates to a method and device for sidelink communication, a terminal, and a storage medium.

In a first aspect, an embodiment of the present disclosure provides a method for sidelink communication. The method is performed by a terminal. The method includes:
determining whether a listen-before-talk (LBT) fails for a sidelink (SL) transmission unit transmitted by the terminal; and
managing, in a case where the SL transmission unit includes a report, the report based on a determination result.

In a second aspect, an embodiment of the present disclosure provides a device for sidelink communication. The device includes:
a processing module configured to determine whether an LBT fails for an SL transmission unit transmitted by a terminal;
the processing module is further configured to manage, in a case where the SL transmission unit includes a report, the report based on a determination result.

In a third aspect, an embodiment of the present disclosure provides a terminal. The terminal includes one or more processors and a memory. A computer program is stored in the memory, where the computer program stored in the memory, when executed by the one or more processors, causes the terminal to perform the method according to the first aspect.

In a fourth aspect, an embodiment of the present disclosure provides a terminal. The terminal includes one or more processors and an interface circuit. The interface circuit is configured to receive code instructions and transmit the code instructions to the one or more processors. The one or more processors are collectively configured to run the code instructions, so as to cause the terminal to perform the method according to the first aspect.

In a fifth aspect, an embodiment of the present disclosure provides a communication system. The communication system includes the device for sidelink communication according to the second aspect, the terminal according to the third aspect, or the terminal according to the fourth aspect.

In a sixth aspect, an embodiment of the present disclosure provides a non-transitory computer-readable storage medium. The non-transitory computer-readable storage medium is configured to store instructions. The instructions, when executed by one or more processors of a terminal, cause the terminal to perform the method according to the first aspect.

In a seventh aspect, the present disclosure further provides a computer program product including a computer program. The computer program, when executed on a computer, causes the computer to perform the method according to the first aspect.

In an eighth aspect, the present disclosure provides a chip system. The chip system includes at least one processor and an interface, and the chip system is configured to support a terminal to achieve the functions involved in the method according to the first aspect, and for instance, a function of determining or processing at least one of data or information involved in the method. In an example design, the chip system further includes a memory. The memory is configured to store a computer program and data necessary for a source auxiliary node. The chip system may be composed of chips, or may include a chip and other discrete devices.

In a ninth aspect, the present disclosure provides a computer program. The computer program, when executed on a computer, causes the computer to perform the method according to the first aspect.

### BRIEF DESCRIPTION OF DRAWINGS

At least one of the foregoing or additional aspects and advantages of the present disclosure will become obvious and comprehensible from the description of embodiments in conjunction with the drawings.

FIG. 1 is a schematic diagram of an architecture of a communication system according to an embodiment of the present disclosure;

FIG. 2 is a schematic flowchart of a method for sidelink communication according to embodiment of the present disclosure;

FIG. 3a is a schematic flowchart of a method for sidelink communication according to another embodiment of the present disclosure;

FIG. 3b is a schematic flowchart of a method for sidelink communication according to yet another embodiment of the present disclosure;

FIG. 3c is a schematic flowchart of a method for sidelink communication according to yet another embodiment of the present disclosure;

FIG. 4a is a schematic flowchart of a method for sidelink communication according to yet another embodiment of the present disclosure;

FIG. 4b is a schematic flowchart of a method for sidelink communication according to yet another embodiment of the present disclosure;

FIG. 4c is a schematic flowchart of a method for sidelink communication according to yet another embodiment of the present disclosure;

FIG. 5 is a schematic structural diagram of a device for sidelink communication according to embodiment of the present disclosure;

FIG. 6 is a schematic structural diagram of a terminal according to an embodiment of the present disclosure; and

FIG. 7 is a schematic structural diagram of a chip according to an embodiment of the present disclosure.

### DETAILED DESCRIPTION OF THE INVENTION

Examples will be described in detail and shown in the accompanying drawings illustratively. When the following description involves the accompanying drawings, unless otherwise specified, an identical number in different accompanying drawings denotes identical or similar elements. Implementations described in the following examples do not denote all implementations consistent with embodiments of the present disclosure. On the contrary, the implementations are merely instances of a device and a method consistent with some aspects of the embodiments of the present disclosure as detailed in the appended claims.

The terms used in the embodiments of the present disclosure are merely to describe the specific embodiments, instead of limiting the embodiments of the present disclosure. The singular forms such as “a,” “an,” and “the” used in the embodiments of the present disclosure and the appended claims are also intended to include the plural forms, unless otherwise clearly stated in the context. It is to be further understood that the term “and/or” used refers to and includes any of one or more of the associated listed items or all combinations.

It is to be understood that although the terms such as first, second, and third may be configured to describe various information in the embodiments of the present disclosure, the information is not to be limited to the terms. The terms are merely configured to distinguish an identical type of signals from each other. For instance, without departing from the scope of the embodiments of the present disclosure, first information may alternatively be referred to as second information, and similarly, second information may alternatively be referred to as first information. Depending on the context, the word “if” used can be interpreted as “when” or “at the time of” or “in response to determining”.

The embodiments of the present disclosure are described in detail, and the embodiments are illustratively shown in accompanying drawings, throughout which identical or similar reference numerals denote identical or similar elements. The embodiments described with reference to the accompanying drawings are illustrative and only intended to explain the present disclosure, instead of limiting the present disclosure.

In order to facilitate understanding, the terms involved in the present disclosure are firstly introduced.

### 1. Listen-Before-Talk (LBT)

The LBT is a widely used technique in radio communication. Before starting transmission, a radio transmitter may first listen to its radio environment to detect whether a channel is idle. In a case where the channel is busy, the radio transmitter waits until the channel is idle, such that channel access conflicts are avoided, and channel spectrum sharing is implemented.

### 2. Sidelink (SL)

The SL is a link for direct communication between terminals.

### 3. Sidelink Channel State Information (SL CSI)

The SL CSI is configured to provide a sidelink channel state indication for a peer terminal.

### 4. Sidelink Inter-User Equipment (UE) Coordination (SL IUC)

In order to assist the peer terminal in better resource selection and to avoid conflicts with other terminals, the SL IUC is introduced. In a case where both the terminal and the peer terminal select resources in an autonomously-selected mode (mode2), the terminal may transmit the SL IUC report to the peer terminal. The SL IUC report may include a preferred resource set or a non-preferred resource set, so as to assist the peer terminal during resource selection.

In a communication system, a manner for triggering the SL CSI report may be as follows: in a case where sidelink control information (SCI) transmitted by the peer terminal to the terminal includes a request message for requesting the SL CSI report, the terminal may trigger the SL CSI report and start a timer associated with the SL CSI report. The timer associated with the SL CSI report may be configured to indicate that the terminal transmits the SL CSI report within operation time of the timer. In addition, after the terminal triggers the SL CSI report, in a case where the terminal has an SL resource for additional transmission and a result of a logical channel prioritization (LCP) procedure is that the SL resource may include a sidelink channel state information medium access control control element (SL CSI MAC CE) and a sub-header of the SL CSI MAC CE, this case indicates that the SL resource for additional transmission may transmit the SL CSI report. The SL CSI MAC CE is configured to include the SL CSI report. In this case, the terminal may instruct a multiplexing and assembling entity of an MAC layer to generate and transmit the SL CSI MAC CE for additional transmission. Then, the terminal may cancel the triggered SL CSI report and stop the timer associated with the SL CSI report.

The LCP procedure may be as follows: the MAC layer of the terminal allocates a resource to each channel based on a priority of each channel (for instance, an SL channel). The description that “a result of an LCP procedure is that the SL resource may include an SL CSI MAC CE and a sub-header of the SL CSI MAC CE” may be understood as follows: the SL resource, for additional transmission, allocated by the MAC layer of the terminal to the terminal may include the SL CSI MAC CE and the sub-header of the SL CSI MAC CE.

The SL IUC report may have two triggering modes, that is, a request-based IUC mechanism and a condition-based IUC mechanism. The request-based IUC mechanism means that the terminal may trigger the transmission of the SL IUC report and start a timer associated with the SL IUC report, after receiving an IUC request message transmitted by the peer terminal. The timer associated with the SL IUC report may be configured to indicate that the terminal transmits the SL IUC report during operation time of the timer. The condition-based IUC mechanism means that the terminal may determine whether a triggering condition is satisfied, and in a case where the triggering condition is satisfied, the terminal may automatically trigger transmission of the SL IUC report based on implementation and start the timer associated with the SL IUC report. In addition, after the terminal triggers the SL IUC report, in a case where the terminal has an SL resource for additional transmission, the result of an LCP procedure is that the SL resource may include a sidelink inter-UE coordination medium access control control element (SL IUC MAC CE) and a sub-header of the SL IUC MAC CE, and the SL IUC MAC CE is configured to include the SL IUC report, this case indicates that the SL resource for additional transmission may transmit the SL IUC report. In this case, the terminal may instruct a multiplexing and assembling entity of an MAC layer to generate and transmit the SL IUC MAC CE. Then, the terminal may cancel the triggered SL-IUC report and stop the timer associated with the SL IUC report.

It may be seen from the description that after the terminal generates the SL CSI report or SL IUC report, the SL CSI report or the SL IUC report may be successfully transmitted to the peer terminal later by default. In this case, the triggered SL CSI report or SL IUC report may be cancelled. Cancellation of the SL CSI report or the SL IUC report may be understood as at least one of: no longer generating the SL CSI report or the SL IUC report, or no longer additionally transmitting the SL CSI report or the SL IUC report.

However, for R18 sidelink, it supports work in an unlicensed spectrum. In a case where terminals are in SL communication with each other through the unlicensed spectrum, the terminals generally need to perform the LBT before transmitting an SL transmission unit. In a case where the LBT is successful, the SL transmission unit may be successfully transmitted. In a case where the LBT fails, the SL transmission unit may not be successfully transmitted.

Based on this, assuming that in R18 Sidelink, the triggered SL CSI report or SL IUC report is cancelled once the terminal generates the SL CSI report or SL IUC report. Then in a case where the LBT fails during the transmission of the SL CSI report or the SL IUC report by the SL transmission unit after the SL CSI report or the SL IUC report is generated, it may result in transmission failure of the SL CSI report or the SL IUC report. Further, since the SL CSI report or the SL IUC report has already been cancelled and the timer associated with the SL CSI report or the SL IUC report has been stopped, the peer terminal cannot receive the SL CSI report or the SL IUC report in a case where a subsequent retransmission resource also fails to transmit. Further, even if there is an additional transmission resource subsequently, the peer terminal still cannot receive the SL CSI report or the SL IUC report because the terminal cannot regenerate the SL CSI report or the SL IUC report for additional transmission. Thus, there is an urgent need for a method to be performed by the terminal in a case where an LBT failure occurs for the SL CSI report or the SL IUC report.

In the communication system, SL communication has two resource allocation modes. One of the modes is a mode (mode 1) of dynamic scheduling by a network device, and the other one is a mode (mode 2) of autonomous-selection by the terminal in a resource pool broadcast by the network device. Dynamic scheduling refers to the network device dynamically allocating an SL resource to the terminal according to cached data reported by the terminal. The dynamic scheduling may include dynamic sidelink grant scheduling and configured sidelink grant scheduling. Autonomous-selection refers to the terminal randomly selecting a transmission resource from the network-broadcast or pre-configured resource pool.

The network device may configure a maximum number of transmissions for the terminal. In a case where the terminal reaches the maximum number of transmissions on the configured SL grant or autonomously-selected SL grant, the terminal needs to clear hybrid automatic repeat request (HARQ) buffer of an HARQ process associated with the transmission. However, at present, in a case where the LBT fails for the SL transmission unit on the configured SL grant or the autonomously-selected SL grant, the terminal cannot know whether to count a number of transmissions by one. Thus, there is also an urgent need for a statistical manner for a transmission count, which is suitable for a case where “the LBT fails for the SL transmission unit.” The configured SL grant and the autonomously-selected SL grant are time-frequency resources. The configured SL grant may be an SL resource scheduled by the network device through configured grant, and the autonomously-selected SL grant may be an SL resource autonomously-selected by the terminal.

Base on this, a method for sidelink communication according to the present disclosure is provided.

For better understanding of a method for sidelink communication according to the embodiments of the present disclosure, a communication system applicable to the embodiments of the present disclosure is firstly described.

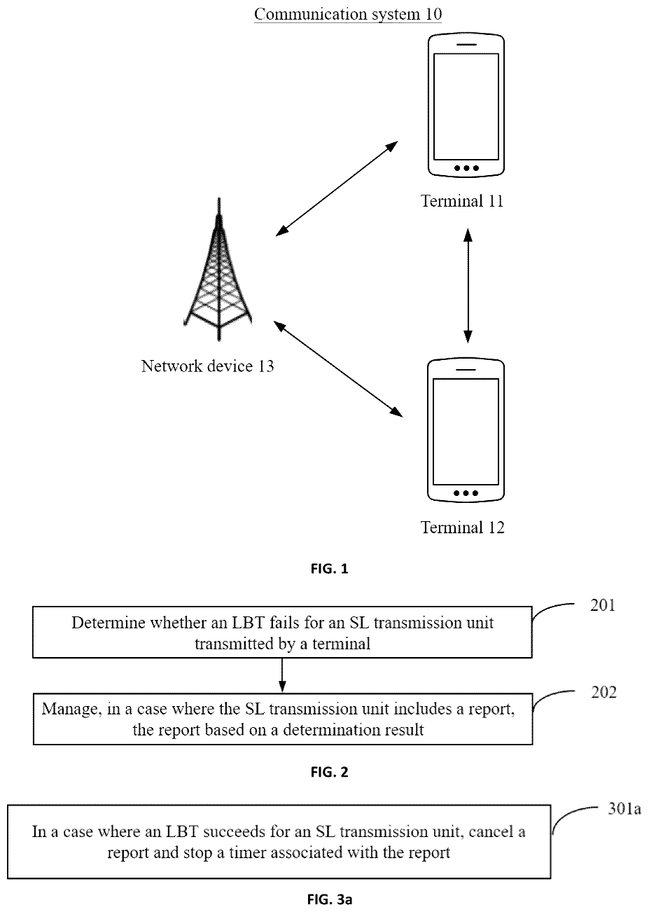

With reference to FIG. 1, FIG. 1 is a schematic diagram of an architecture of a communication system 10 according to an embodiment of the present disclosure. The communication system 10 may include, but is not limited to, a terminal and a network device. Terminals are connected through SL. A number and a form of the devices shown in FIG. 1 are only illustrative and do not limit the embodiments of the present disclosure. In practical application, the communication system 10 may include one or more terminals and one or more network devices. For instance, the communication system 10 shown in FIG. 1 may include two terminals 11 and 12 and one network device 13, the terminal 11 is connected to the terminal 12 through SL.

It is to be noted that technical solutions of the embodiments of the present disclosure may be applied to various types of communication systems, such as a long term evolution (LTE) system, a 5th generation (5G) mobile communication system, a 5G new radio (NR) system, or other novel mobile communication systems in the future.

The terminals 11 and 12 in the embodiments of the present disclosure may be entities, for instance, mobile phones, configured to receive or transmit signals on a user side. The terminal may also be referred to as a terminal, user equipment (UE), a mobile station (MS), a mobile terminal (MT), etc. The UE may be a vehicle having a communication function, an intelligent vehicle, a mobile phone, a wearable device, a portable android device (Pad), a computer having a radio transceiving function, a virtual reality (VR) terminal, an augmented reality (AR) terminal, a radio terminal in industrial control, a radio terminal in self-driving, a radio terminal in remote medical surgery, a radio terminal in smart grid, a radio terminal in transportation safety, a radio terminal in smart city, a radio terminal in smart home, etc. The embodiment of the present disclosure does not limit specific technologies and specific device forms used by the UE.

The network device 13 in the embodiment of the present disclosure is an entity configured to transmit or receive signals on a network side. For instance, the network device 13 may be an evolved NodeB (eNB), a transmission reception point (TRP), a next generation NodeB (gNB) in the NR system, a base station in other future mobile communication systems, or an access node in a wireless fidelity (WiFi) system. The embodiment of the present disclosure does not limit specific technologies and specific device forms used by the network device. The network device according to the embodiment of the present disclosure may be composed of a central unit (CU) and a distributed unit (DU). The CU may also be referred to as a control unit. With a structure of CU-DU, protocol layers of the network device, for instance, a base station, may be separated. Functions of some protocol layers are centrally controlled by the CU while functions of the other or all protocol layers are distributed in the DU, and the DU is centrally controlled by the CU.

It may be understood that the communication system described in the embodiment of the present disclosure is intended to describe the technical solution of the embodiment of the present disclosure more clearly, instead of limiting the technical solution provided by the embodiment of the present disclosure. Those of ordinary skill in the art may know that the technical solution provided by the embodiment of the present disclosure is also applicable to similar technical problems with evolution of a system structure and emergence of new service cases.

The method and device for sidelink communication, the device and the storage medium according to the embodiments of the present disclosure are described in detail with reference to the accompanying drawings.

It is to be noted that in the present disclosure, the method for sidelink communication according to any one of embodiments may be performed independently, and any implementation in the embodiments may be performed independently, in combination with other embodiments, together with implementations in other embodiments, or in combination with any one of technical solutions in the related art.

FIG. 2 is a schematic flowchart of a method for sidelink communication according to an embodiment of the present disclosure. The method is performed by a terminal. As shown in FIG. 2, the method for sidelink communication may include steps 201 to 202.

Step 201, determining whether an LBT fails for an SL transmission unit transmitted by the terminal.

For example, in an embodiment of the present disclosure, the SL transmission unit may be a sidelink medium access control protocol data unit (SL MAC PDU). The SL MAC PDU may be a data packet transmitted between terminals through an SL resource. The SL MAC PDU is only an illustrative introduction of the SL transmission unit. The SL transmission unit is not limited in the present disclosure. Other SL transmission units for communication between the terminals fall within the protection scope of the present disclosure.

In an embodiment of the present disclosure, determining whether the LBT fails for the SL transmission unit transmitted by the terminal may include the following steps:
determining that the LBT succeeds for the SL transmission unit in a case where the terminal does not receive an LBT failure indication (for instance, a higher layer of the terminal does not receive an LBT failure indication transmitted by a physical layer of the terminal); or
determining that the LBT fails for the SL transmission unit in a case where the terminal receives the LBT failure indication (for instance, a higher layer of the terminal receives an LBT failure indication transmitted by a physical layer of the terminal).

In an embodiment of the present disclosure, the description of “LBT fails” may be understood as follows: the terminal fails to transmit the SL transmission unit as the terminal does not monitor an idle channel. The description of “the LBT succeeds” may be understood as follows: the terminal listens to an idle channel configured to transmit the SL transmission unit on an SL resource.

Step 202, managing a report based on a determination result in a case where the SL transmission unit includes the report.

In an embodiment of the present disclosure, the SL transmission unit may include the report. The report may be a related report during SL communication. For instance, the report may be an SL CSI report or an SL IUC report. In a case where the report is the SL CSI report, the SL transmission unit may include a sidelink channel state information medium access control control element (SL CSI MAC CE). The SL CSI MAC CE is configured to include the SL CSI report. In a case where the report is the SL IUC report, the SL transmission unit may include a sidelink inter-UE coordination medium access control control element (SL IUC MAC CE). The SL IUC MAC CE is configured to include the SL IUC report. It is to be noted that the SL CSI report and the SL IUC report are only illustrative introduction, names of the reports are not limited in the present disclosure, and other reports fall within the protection scope of the present disclosure.

In an embodiment of the present disclosure, the report may be triggered and generated by the terminal based on at least one of a request of a peer terminal or a triggering condition. After the report is triggered, in a case where there is an SL resource for additional transmission and a result of an LCP procedure is that the SL resource for additional transmission may include an SL MAC CE (for instance, the SL CSI MAC CE or the SL IUC MAC CE) and a sub-header of the SL MAC CE, this case indicates that the terminal may transmit the report currently. In this case, the terminal may generate the report, and transmit the report to the peer terminal with the generated report included in the SL transmission unit. For instance, when the peer terminal requests the SL CSI report from the terminal, in a case where there is the SL resource for additional transmission and the result of the LCP procedure is that the SL resource may include the SL CSI MAC CE and a sub-header of the SL CSI MAC CE, this case indicates that the terminal may generate the SL CSI report, and transmit the report to the peer terminal with the SL CSI report included in the SL transmission unit.

For example, in an embodiment of the present disclosure, managing the report based on the determination result may include the following steps:
in a case where the LBT succeeds for the SL transmission unit, cancelling the report, and stopping a timer associated with the report;
in a case where the LBT fails for the SL transmission unit, not cancelling the report, not stopping the timer associated with the report, and retransmitting the SL transmission unit during operation of the timer associated with the report; or
in a case where the LBT fails for the SL transmission unit, not cancelling the report, not stopping the timer associated with the report, regenerating the report, and transmitting the regenerated report during the operation of the timer associated with the report.

For example, in some embodiments, regenerating the report, and transmitting the regenerated report during the operation of the timer associated with the report may include the following steps:
in a case where the terminal has an SL resource for additional transmission and the SL resource is capable of transmitting the report, regenerating the report, and transmitting the regenerated report through the SL resource during the operation of the timer associated with the report.

For example, in some embodiments, regenerating the report may include the following step: autonomously determining, by the terminal, whether to regenerate the report based on implementation.

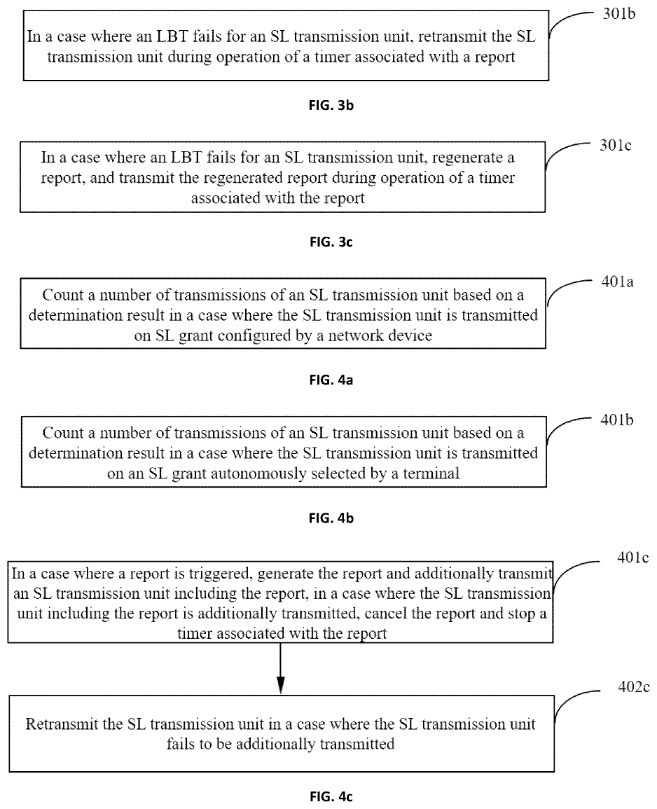

Reference may be made to the following description of the embodiments of FIG. 3a to FIG. 3c for detailed introduction of the sections.

As can be seen from the description, in the embodiment corresponding to FIG. 2 of the present disclosure, in a case where the terminal manages the report included in the SL transmission unit, management is performed based on whether the LBT fails for the SL transmission unit. Whether the LBT failing for the SL transmission may indicate whether the report in the SL transmission unit is transmitted successfully. In this way, the terminal manages the report based on whether the report is successfully transmitted, rather than directly managing the report after the report is generated. Based on this, in a case where the terminal determines that the report is not successfully transmitted, management of the report can ensure successful retransmission of the report. Thus, it can be ensured that the report may be successfully transmitted to the peer terminal. Compared with the method of “directly managing the report after generating the report (for instance, directly cancelling the triggered report)”, the method of the embodiment of FIG. 2 of the present disclosure may avoid a situation that “after the report is generated, in a case where the LBT fails for the report, the peer terminal cannot receive the report in a case where a subsequent retransmission resource also fails to transmit, because the report has already been cancelled and the timer associated with the report has been stopped. Moreover, even if there is an additional transmission resource subsequently, the peer terminal still cannot receive the report because the terminal cannot regenerate the report for additional transmission.” Thus, stability of SL communication is ensured.

In conclusion, in the method for sidelink communication according to the present disclosure, the terminal manages the report in the SL transmission unit based on the determination result after determining whether the LBT fails for the SL transmission unit. Based on this, the terminal may perform targeted management on the report in the SL transmission unit according to the determination result. In this way, in a case where the LBT fails for the SL transmission unit, management of the report may cause successful retransmission of the report. Thus, a transmission success rate of the report is improved, and stability of SL communication is ensured.

FIG. 3a is a schematic flowchart of a method for sidelink communication according to an embodiment of the present disclosure. The method is performed by a terminal. As shown in FIG. 3a, the method for sidelink communication may include step 301a.

Step 301a, in a case where LBT succeeds for an SL transmission unit, cancelling a report, and stopping a timer associated with the report.

The report is associated with one timer. The timer may be configured to indicate that the terminal transmits the report associated with the timer during operation time of the timer. Timing duration of the timer may be equal to a delay requirement of the report. The delay requirement may be configured for the terminal by the peer terminal, and for instance, configured for the terminal by the peer terminal through PC5 radio resource control (RRC) signaling.

For instance, assuming that the report is a CSI report, the peer terminal may configure sl-Latency BoundCSI-Report for the terminal through the PC5-RRC signaling. The sl-LatencyBoundCSI-Report indicates a delay requirement of the CSI report. In this case, duration of a timer associated with the CSI report may be equal to the delay requirement indicated by the sl-LatencyBoundCSI-Report. Alternatively, assuming that the report is an IUC report, the peer terminal may configure sl-LatencyBoundIUC-Report for the terminal through the PC5-RRC signaling. The sl-LatencyBoundCSI-Report indicates a delay requirement of the IUC report. In this case, duration of a timer associated with the IUC report may be equal to the delay requirement indicated by the sl-LatencyBoundCSI-Report.

In an embodiment of the present disclosure, with respect to the mentioned timer, in a case where a triggering condition of the report is satisfied (reference may be made to introduction at the beginning of the embodiment for triggering of the report), the terminal may start the timer associated with the report. In this way, the terminal transmits the report to the peer terminal during operation of the timer.

In an embodiment of the present disclosure, the LBT succeeding for the SL transmission unit indicates that the report included in the SL transmission unit is transmitted successfully. That is, the peer terminal receives the report. In this case, the report does not need to be retransmitted. Then, the terminal may cancel the report and stop the timer associated with the report. Cancellation of the report may be understood as at least one of: no longer generating the report, or no longer additionally transmitting the report.

It is to be noted that in an embodiment of the present disclosure, in a case where the timer expires, the terminal cancels the report associated with the timer at the moment when the timer expires in a case where the terminal does not cancel the report associated with the timer.

In conclusion, in the method for sidelink communication according to the present disclosure, in a case where the LBT succeeds for the SL transmission unit, the report is cancelled, and the timer associated with the report is stopped. That is, in the present disclosure, in a case where it is determined that the SL transmission unit is successfully transmitted (that is, in a case where the report in the SL transmission unit is successfully transmitted), the report may be cancelled, and the timer associated with the report may be stopped. Thus, successful transmission of the report may be ensured. In a case where it is determined that the SL transmission unit is successfully transmitted, the report is cancelled, and the timer associated with the report is stopped. In this way, extra consumption of resources may be avoided, and resource overhead may be reduced.

FIG. 3b is a schematic flowchart of a method for sidelink communication according to an embodiment of the present disclosure. The method is performed by a terminal. As shown in FIG. 3b, the method for sidelink communication may include step 301b.

Step 301b, in a case where an LBT fails for an SL transmission unit, retransmitting the SL transmission unit during operation of a timer associated with a report.

Reference may be made to the description of the embodiment of FIG. 3a for related introduction of the timer.

For example, in an instance of the present disclosure, the LBT failing for the SL transmission unit indicates that the report included in the SL transmission unit fails to be transmitted. That is, a peer terminal does not receive the report. In this case, the terminal does not cancel the report or stop the timer associated with the report. The terminal retransmits the SL transmission unit during the operation of the timer associated with the report until it is determined that the LBT succeeds for the SL transmission unit during the operation of the timer. Then, the terminal cancels the report, and stops the timer associated with the report. In this way, it is ensured that the report in the SL transmission unit may be successfully transmitted to the peer terminal, and stability of SL communication is ensured.

In conclusion, in the method for sidelink communication according to the present disclosure, in a case where the LBT fails for the SL transmission unit, the SL transmission unit is retransmitted during the operation of the timer associated with the report. In this case, the SL transmission unit is retransmitted, such that a transmission success rate of the report in the SL transmission unit may be improved, and stability of SL communication may be ensured.

FIG. 3c is a schematic flowchart of a method for sidelink communication according to an embodiment of the present disclosure. The method is performed by a terminal. As shown in FIG. 3c, the method for sidelink communication may include step 301c.

Step 301c, in a case where an LBT fails for an SL transmission unit, regenerating a report, and transmitting the regenerated report during operation of a timer associated with the report.

For example, in an instance of the present disclosure, the LBT failing for the SL transmission unit indicates that the report included in the SL transmission unit fails to be transmitted. That is, a peer terminal does not receive the report. In this case, the terminal does not cancel the report or stop the timer associated with the report. The terminal may regenerate the report and transmit the regenerated report during the operation of the timer associated with the report. In this way, it is ensured that the peer terminal may successfully receive a requested report, and stability of SL communication is ensured.

It is to be noted that in an embodiment of the present disclosure, generating a report, and transmitting the regenerated report during operation of a timer associated with the report may include the following steps:
in a case where the terminal determines that the terminal currently has an SL resource for additional transmission and the SL resource for additional transmission is capable of transmitting the report, regenerating the report, and transmitting the regenerated report through the SL resource for additional transmission during the operation of the timer associated with the report.

The description that “the SL resource is capable of transmitting the report” may be understood as follows: a result of an LCP procedure is that the SL resource may include an SL MAC CE (for instance, an SL CSI MAC CE or an SL IUC MAC CE) and a sub-header of the SL MAC CE. The SL transmission unit includes the report. For instance, assuming that the report is an SL CSI report, the LCP result of the SL resource being that the SL resource may include the SL CSI MAC CE and a sub-header of the SL CSI MAC CE indicates that the SL resource may transmit the SL CSI report. Alternatively, assuming that the report is an SL IUC report, the LCP result of the SL resource being that the SL resource may include the SL IUC MAC CE and a sub-header of the SL IUC MAC CE indicates that the SL resource may transmit the SL IUC report.

For example, in another embodiment of the present disclosure, the terminal may autonomously determine whether to regenerate the report based on implementation. In a case where it is determined that the report is to be regenerated, the terminal may regenerate the report, and transmit the regenerated report during the operation of the timer associated with the report.

In addition, in an embodiment of the present disclosure, the action that “a report is regenerated” may be performed by an entity (for instance, a multiplexing and assembling entity) of an MAC layer of the terminal.

In conclusion, in the method for sidelink communication according to the present disclosure, in a case where the LBT fails for the SL transmission unit, the terminal may regenerate the report, and transmit the regenerated report during the operation of the timer associated with the report. In this case, the report is regenerated, and the regenerated report is transmitted, such that a transmission success rate of the report in the SL transmission unit may be improved, and stability of SL communication may be ensured.

FIG. 4a is a schematic flowchart of a method for sidelink communication according to an embodiment of the present disclosure. The method is performed by a terminal. As shown in FIG. 4a, the method for sidelink communication may include step 401a.

Step 401a, counting a number of transmissions of an SL transmission unit based on a determination result in a case where the SL transmission unit is transmitted on SL grant configured by a network device.

The SL grant configured by a network device may be understood as an SL resource scheduled by the network device through configured grant.

In an embodiment of the present disclosure, the description that “the number of transmissions of the SL transmission unit is counted based on the determination result” may include the following step: not increasing the number of transmissions of the SL transmission unit by one in a case where the LBT fails for the SL transmission unit.

In conclusion, in the method for sidelink communication according to the present disclosure, in a case where the SL transmission unit is transmitted on the SL grant configured by the network device, the terminal may count the number of transmissions of the SL transmission unit based on the determination result. In a case where the LBT fails for the SL transmission unit, the number of transmissions of the SL transmission unit is not increased by one. In this case, the present disclosure provides a statistical method for a transmission count, this method is suitable for a case where the LBT fails for the SL transmission unit. In this way, in a case where the LBT fails for the SL transmission unit, the terminal may count the number of transmissions of the SL transmission unit.

FIG. 4b is a schematic flowchart of a method for sidelink communication according to an embodiment of the present disclosure. The method is performed by a terminal. As shown in FIG. 4b, the method for sidelink communication may include the following step 401b.

Step 401b, counting a number of transmissions of an SL transmission unit based on a determination result in a case where the SL transmission unit is transmitted on SL grant autonomously selected by the terminal.

The SL grant autonomously selected by the terminal may be understood as an SL resource autonomously selected by the terminal.

In an embodiment of the present disclosure, the description that “the number of transmissions of the SL transmission unit is counted based on the determination result” may include the following step: not increasing the number of transmissions of the SL transmission unit by one in a case where the LBT fails for the SL transmission unit.

In conclusion, in the method for sidelink communication according to the present disclosure, in a case where the SL transmission unit is transmitted on the SL resource autonomously-selected by the terminal, the terminal may count the number of transmissions of the SL transmission unit based on the determination result. In a case where the LBT fails for the SL transmission unit, the number of transmissions of the SL transmission unit is not increased by one. In this case, the present disclosure provides a statistical method for a transmission count, this method is suitable for a case where the LBT fails for the SL transmission unit. In this way, in a case where the LBT fails for the SL transmission unit, the terminal may count the number of transmissions of the SL transmission unit.

FIG. 4c is a schematic flowchart of a method for sidelink communication according to an embodiment of the present disclosure. The method is performed by a terminal. As shown in FIG. 4c, the method for sidelink communication may include steps 401c to 402c.

Step 401c, in a case where a report is triggered, generating the report and additionally transmitting an SL transmission unit including the report; in a case where the SL transmission unit including the report is additionally transmitted, cancelling the report, and stopping a timer associated with the report.

In an embodiment of the present disclosure, the report being triggered indicates that the report currently needs to be transmitted to a peer terminal. In this case, the terminal may start the timer associated with the report, generate the report, and further additionally transmit the SL transmission unit including the report (that is, the report is included in the SL transmission unit and transmitted to the peer terminal). In addition, in a case where the SL transmission unit including the report is additionally transmitted, the report may be cancelled, and the timer associated with the report may be stopped. Cancellation of the report may be understood as at least one of: no longer generating the report, or no longer additionally transmitting the report. That is, after cancellation of the report, the terminal performs at least one of: no longer generating the report, or no longer additionally transmitting the report.

It is to be noted that after another embodiment, the report may be cancelled after the SL transmission unit including the report is additionally transmitted.

In an embodiment of the present disclosure, in a case where the terminal generates the report, regardless of whether the SL transmission unit including the report is successfully transmitted, the report may be cancelled, and the timer associated with the report may be stopped. Successful transmission of the SL transmission unit including the report means that an LBT failure indication is not received for transmission of the SL transmission unit including the report. Failed transmission of the SL transmission unit including the report means that an LBT failure indication is received for transmission of the SL transmission unit including the report. Based on this, in an embodiment of the present disclosure, in a case where the terminal generates the report, regardless of whether the LBT failure indication is received (regardless of an LBT result), the report may be cancelled, and the timer associated with the report may be stopped.

It is to be noted that in an embodiment of the present disclosure, an execution order of “generating the report and starting the timer associated with the report” is not limited. It is possible to start the timer associated with the report after generating the report, generate the report after starting the timer associated with the report, or start the timer associated with the report and generate the report at the same time. An execution order of “cancelling the report and stopping the timer associated with the report” is not limited. It is possible to stop the timer associated with the report after cancelling the report, cancel the report after stopping the timer associated with the report, or stop the timer associated with the report and cancel the report at the same time.

The embodiment corresponding to FIG. 4c is different from the above-mentioned embodiments in that, in the embodiment corresponding to FIG. 4c, in a case where the terminal generates the report, the report is directly cancelled rather than “managing the report based on whether the LBT fails for the SL transmission unit including the report” in the above-mentioned embodiments.

In addition, reference may be made to the description of the embodiment corresponding to FIG. 2 for related introduction of the report, and reference may be made to related introduction before the embodiment for a manner for triggering the report.

Step 402c, retransmitting the SL transmission unit in a case where the SL transmission unit fails to be additionally transmitted.

In conclusion, in the method for sidelink communication according to the present disclosure, in a case where the report is triggered, the terminal may generate the report, and additionally transmit the SL transmission unit including the report. In addition, in a case where the SL transmission unit including the report is additionally transmitted, the report is cancelled, and the timer associated with the report is stopped. Then, in a case where the SL transmission unit fails to be additionally transmitted, the SL transmission unit may be retransmitted. Thus, in the method of the present disclosure, even if the report is cancelled, in a case where the report fails to be additionally transmitted, the report may be further retransmitted. In this way, it is ensured that the report may be successfully transmitted to the peer terminal, and stability of SL communication is ensured.

The method of the present disclosure will be introduced through instances.

For example, in some embodiments, the LBT succeeds for an SL transmission unit including a CSI MAC CE, and a terminal cancels a triggered CSI report and stops a timer associated with the triggered CSI report.

Embodiment: the description that the LBT succeeds for the SL transmission unit including the CSI MAC CE indicates that an LBT failure indication is not received for the transmission of the SL transmission unit including the CSI MAC CE.

Embodiment: in a case where an SL transmission unit including a CSI MAC CE fails to be transmitted, that is, an LBT failure indication is received for the transmission of the SL transmission unit including the CSI MAC CE, a terminal does not cancel a triggered CSI report, or stop a CSI timer associated with a triggered CSI report. The terminal may retransmit the SL transmission unit including the CSI MAC CE during operation of the timer associated with the triggered CSI report. In a case where it is determined that the LBT succeeds for the SL transmission unit including the CSI MAC CE (the LBT failure indication is not received), the terminal cancels the triggered CSI report, and stops the timer associated with the triggered CSI report.

For example, in some embodiments, the terminal determines that the SL transmission unit including the CSI MAC CE fails to be transmitted due to LBT failure, and the terminal regenerates the CSI report.

Embodiment: assuming that an SL transmission unit including a CSI MAC CE fails to be transmitted, that is, an LBT failure indication is received for the transmission of the SL transmission unit including the CSI MAC CE, then in a case where a terminal determines that there is an SL resource for additional transmission during operation of a timer associated with a triggered CSI report and a result of logical channel prioritization is that the SL resource may include an SL-CSI MAC CE and a sub-header of the SL-CSI MAC CE, the terminal instructs a multiplexing and assembling entity to generate the SL-CSI MAC CE, regenerates the SL transmission unit including the CSI MAC CE, and transmits the SL transmission unit. In an example, the terminal may determine whether to regenerate the CSI report.

For example, in some embodiments, LBT succeeds for an SL transmission unit including an IUC MAC CE, and a terminal cancels a triggered IUC report and stops a timer associated with the triggered IUC report.

Embodiment: the description that the LBT succeeds for the SL transmission unit including the IUC MAC CE indicates that an LBT failure indication is not received for the transmission of the SL transmission unit including the IUC MAC CE.

Embodiment: in a case where an SL transmission unit including an IUC MAC CE fails to be transmitted, that is, an LBT failure indication is received for the transmission of the SL transmission unit including the IUC MAC CE, a terminal does not cancel a triggered IUC report, or stop an IUC timer associated with a triggered IUC report. The terminal may retransmit the SL transmission unit including the IUC MAC CE during operation of the timer associated with the triggered CSI report. In a case where it is determined that the LBT succeeds for the SL transmission unit including the IUC MAC CE (the LBT failure indication is not received), the terminal cancels the triggered IUC report, and stops the timer associated with the triggered IUC report.

For example, in some embodiments, the terminal determines that the SL transmission unit including the IUC MAC CE fails to be transmitted due to LBT failure, and the terminal regenerates the IUC report.

Embodiment: assuming that an SL transmission unit including an IUC MAC CE fails to be transmitted, that is, an LBT failure indication is received for the transmission of the SL transmission unit including the IUC MAC CE, then in a case where a terminal determines that there is an SL resource for additional transmission during operation of a timer associated with a triggered IUC report and a result of logical channel prioritization is that the SL resource may include an SL-IUC MAC CE and a sub-header of the SL-IUC MAC CE, the terminal instructs a multiplexing and assembling entity to generate the SL-IUC MAC CE, regenerates the SL transmission unit including the IUC MAC CE, and transmits the SL transmission unit. In an example, the terminal may determine whether to regenerate the IUC report.

For example, in some embodiments, the terminal determines that the SL transmission unit transmitted on configured grant (that is, the configured SL grant) fails to be transmitted due to LBT failure, and the terminal does not increase a number of transmissions of the SL transmission unit by one.

For example, in some embodiments, the terminal determines that the SL transmission unit transmitted on autonomously-selected grant (that is, the autonomously-selected SL grant) fails to be transmitted due to LBT failure, and the terminal does not increase a number of transmissions of the SL transmission unit by one.

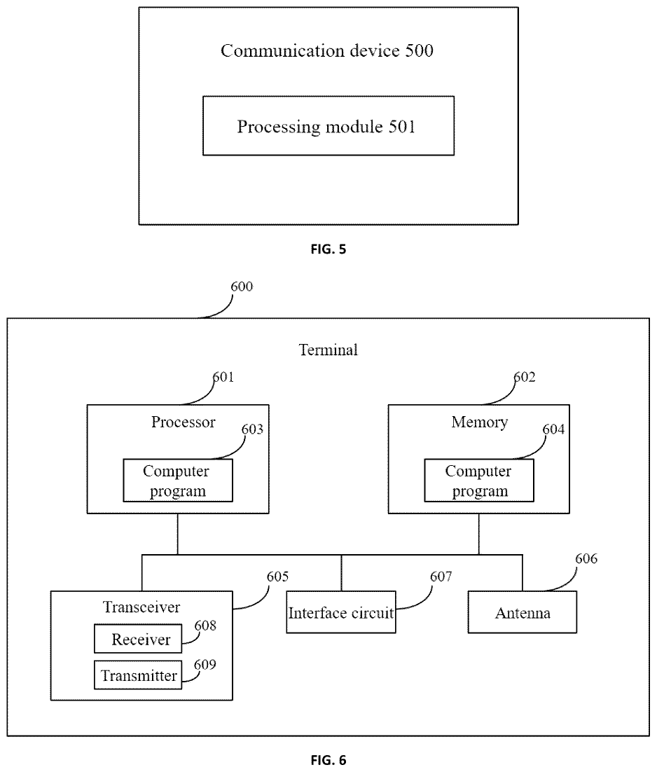

FIG. 5 is a schematic structural diagram of a device 500 for sidelink communication according to an embodiment of the present disclosure. As shown in FIG. 5, the device 500 may include:
a processing module 501 configured to determine whether a listen-before-talk (LBT) fails for a sidelink (SL) transmission unit transmitted by a terminal;
the processing module 501 is further configured to manage, in a case where the SL transmission unit includes a report, the report based on a determination result.

In conclusion, the device for sidelink communication according to the embodiment of the present disclosure manages the report in the SL transmission unit based on the determination result after determining whether the LBT fails for the SL transmission unit. Based on this, the device for sidelink communication may perform targeted management on the report in the SL transmission unit according to the determination result. In this way, in a case where the LBT fails for the SL transmission unit, management of the report may cause successful retransmission of the report. Thus, a transmission success rate of the report may be improved, and stability of SL communication may be ensured.

For example, in an embodiment of the present disclosure, the processing module 501 is further configured to:
in a case where the LBT succeeds for the SL transmission unit, cancel the report, and stop a timer associated with the report;
in a case where the LBT fails for the SL transmission unit, not cancel the report, not stop the timer associated with the report, and retransmit the SL transmission unit during operation of the timer associated with the report; or
in a case where the LBT fails for the SL transmission unit, not cancel the report, not stop the timer associated with the report, regenerate the report, and transmit the regenerated report during operation of the timer associated with the report.

For example, in an embodiment of the present disclosure, the processing module 501 is further configured to:
in a case where the terminal has an SL resource for additional transmission and the SL resource is capable of transmitting the report, regenerate the report and transmit the regenerated report through the SL resource during the operation of the timer associated with the report.

For example, in an embodiment of the present disclosure, the processing module 501 is further configured to:
autonomously determine, by the terminal, whether to regenerate the report based on implementation.

For example, in an embodiment of the present disclosure, the report includes at least one of:
a sidelink channel state information (SL CSI) report; or
a sidelink inter-user equipment (UE) coordination (SL IUC) report.

For example, in an embodiment of the present disclosure,
in a case where the report is the SL CSI report, the SL transmission unit includes a sidelink channel state information medium access control control element (SL CSI MAC CE), where the SL CSI MAC CE includes the SL CSI report; and
in a case where the report is the SL IUC report, the SL transmission unit includes a sidelink inter-UE coordination medium access control control element (SL IUC MAC CE), where the SL IUC MAC CE includes the SL IUC report.

For example, in an embodiment of the present disclosure, the device 500 is further configured to:
count a number of transmissions of the SL transmission unit based on the determination result in a case where the SL transmission unit is transmitted on at least one of an SL grant configured by a network device or an SL grant autonomously selected by the terminal.

For example, in an embodiment of the present disclosure, the processing module 501 is further configured to:
not increase the number of transmissions of the SL transmission unit by one in a case where the LBT fails for the SL transmission unit.

For example, in an embodiment of the present disclosure, the processing module 501 is further configured to:
determine that the LBT succeeds for the SL transmission unit in a case where the terminal does not receive an LBT failure indication; or
determine that the LBT fails for the SL transmission unit in a case where the terminal receives the LBT failure indication.

For example, in an embodiment of the present disclosure, the SL transmission unit includes a sidelink medium access control protocol data unit (SL MAC PDU).

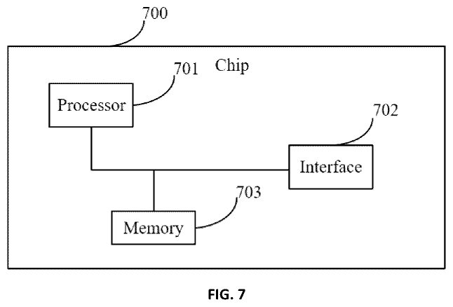

With reference to FIG. 6, FIG. 6 is a schematic structural diagram of a terminal 600 according to an embodiment of the present disclosure. The terminal may be configured to implement the method according to the method embodiment. Reference may be made to the description in the method embodiment for details.

The terminal 600 may include one or more processors 601. The processor 601 may be a general-purpose processor, a special-purpose processor, etc. For instance, the processor may be a baseband processor or a central processing unit. The baseband processor may be configured to process a communication protocol and communication data. The central processing unit may be configured to control the communication device (for instance, a base station, a baseband chip, a terminal, a terminal chip, a distributed unit (DU), or a centralized unit (CU)), execute a computer program, and process data of the computer program.

For example, the terminal 600 may further include one or more memories 602. The memory may store a computer program 604. The processor 601 executes the computer program 604, so as to cause the terminal 600 to perform the method according to the method embodiment. For example, the memory 602 may further store data. The terminal 600 and the memory 602 may be arranged separately or integrated with each other.

For example, the terminal 600 may further include a transceiver 605 and an antenna 606. The transceiver 605 may be referred to as a transceiving unit, a transceiving machine, a transceiving circuit, etc., and is configured to achieve a transceiving function. The transceiver 605 may include a receiver 608 and a transmitter 609. The receiver 608 may be referred to as a reception machine or a reception circuit, and is configured to achieve a reception function. The transmitter 609 may be referred to as a transmission machine or a transmission circuit, and is configured to achieve a transmission function.

For example, the terminal 600 may further include one or more interface circuits 607. The interface circuit 607 is configured to receive code instructions and transmit the code instructions to the processor 601. The processor 601 runs the code instructions, so as to cause the terminal 600 to perform the method according to the method embodiment.

In one implementation, the processor 601 may include the transceiver configured to achieve reception and transmission functions. For instance, the transceiver may be a transceiving circuit, an interface, or an interface circuit. The transceiving circuit, the interface or the interface circuit configured to achieve the reception and transmission functions may be separated or integrated. The transceiving circuit, the interface or the interface circuit may be configured to read and write codes/data. Alternatively, the transceiving circuit, the interface or the interface circuit may be configured to transmit or transfer a signal.

In one implementation, the processor 601 may store a computer program 603. The computer program 603 runs on the processor 601, so as to cause the terminal 600 to perform the method according to the method embodiment. The computer program 603 may be cured in the processor 601. In this case, the processor 601 may be implemented by hardware.

In one implementation, the terminal 600 may include a circuit. The circuit may achieve a transmission or reception or communication function in the method embodiment. The processor and the transceiver according to the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and the transceiver may be manufactured through various IC process technologies, such as a complementary metal oxide semiconductor (CMOS), an n-metal oxide semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

A structure of the terminal according to the embodiment may not be limited by FIG. 6. The terminal may be an independent device or may be part of a large device. For instance, the terminal may be:
(1) an independent integrated circuit (IC), a chip, a chip system, or a subsystem;
(2) a set having one or more ICs, where the IC set may also include a storage component configured to store data and a computer program;
(3) an ASIC, for instance, a modem;
(4) a module that may be embedded in other devices;
(5) a receiver, a terminal, an intelligent terminal, a cellular phone, a radio device, a handset, a mobile unit, an in-vehicle device, a network device, a cloud device, an artificial intelligence device, etc.; and
(6) a different device.

In a case that the terminal may be a chip, reference may be made to a schematic structural diagram of the chip 700 shown in FIG. 7. The chip 700 shown in FIG. 7 includes a processor 701 and an interface 702. A number of processors 701 may be one or more. A number of interfaces 702 may be greater than one.

For example, the chip 700 further includes a memory 703. The memory 703 is configured to store a computer program and data that are necessary.

Those skilled in the art may further understand that various illustrative logical blocks and steps listed in the embodiments of the present disclosure may be implemented by electronic hardware, computer software, or a combination of both. Whether the function is achieved by hardware or software depends on specific applications and design requirements of an entire system. Those skilled in the art may use different methods to achieve the functions for each particular application, but such implementation is not considered to fall beyond the protection scope of the embodiments of the present disclosure.

The present disclosure further provides a non-transitory computer readable storage medium. The non-transitory computer readable storage medium stores instructions. When the instructions are executed by a computer, functions of any one of the method embodiments are achieved.

The present disclosure further provides a computer program product. When the computer program product is executed by a computer, functions of any one of the method embodiments are achieved.

In the present disclosure, the terminal manages the report in the SL transmission unit based on the determination result after determining whether the LBT fails for the SL transmission unit. Based on this, the terminal may perform targeted management of the report in the SL transmission unit according to the determination result. In this way, in a case where the LBT fails for the SL transmission unit, management of the report may cause successful retransmission of the report. Thus, a transmission success rate of the report is improved, and stability of SL communication is ensured.

The embodiments may be partially or completely implemented with software, hardware, firmware or any combinations of them. During implementation with software, the embodiments may be partially or completely implemented in a form of a computer program product. The computer program product includes one or more computer programs. When the computer program is loaded and executed on the computer, flows or functions according to the embodiments of the present disclosure are partially or completely generated. The computer may be a general-purpose computer, a special-purpose computer, a computer network, or another programmable device. The computer program may be stored in a computer-readable storage medium or transmitted from one computer-readable storage medium to another computer-readable storage medium. For instance, the computer program may be transmitted from one website, one computer, one server or one data center to another website, another computer, another server or another data center in a wired manner (for instance, through a coaxial cable, an optical fiber, or a digital subscriber line (DSL)) or a wireless manner (for instance, through infrared waves, radio, or microwaves). The computer-readable storage medium may be any available medium that may be accessed by the computer or a data storage device such as an integration server and data center that includes one or more available media. The available medium may be a magnetic medium (for instance, a floppy disk, a hard disk, or a magnetic tape), an optical medium (for instance, a high-density digital video disc (DVD)), a semiconductor medium (for instance, a solid state disk (SSD)), etc.

Those of ordinary skill in the art may understand that numerical symbols such as “first” and “second” involved in the present disclosure are only for convenience of description, instead of limiting the scope of the embodiments of the present disclosure, and further indicate a sequence.

“At least one” in the present disclosure may also be described as “one or more,” and “a plurality of” may indicate two, three, four, or more, which are not limited by the present disclosure. In the embodiment of the present disclosure, for a technical feature, technical features in the technical feature are distinguished by “first,” “second,” “third,” “A,” “B,” “C,” “D,” etc. The technical features described by the “first,” “second,” “third,” “A,” “B,” “C” and “D” are not in order of succession or order of size.

A correspondence shown in each table in the present disclosure may be configured or predefined. Values of signals in each table are only illustrative, and may be configured to be other values, which are not limited by the present disclosure. When the correspondence between information and all parameters is configured, not all the correspondences indicated in each table have to be configured. For instance, in the tables in the present disclosure, the correspondence shown in some rows does not have to be configured. For another instance, appropriate variation and adjustment may be conducted on the basis of the table, such as splitting and merging. Names of the parameters indicated by headings in the tables may also be other names that may be understood by a communication device, and values or representations of the parameters may also be other values or representations that may be understood by the communication device. The tables may also use other data structures during implementation, such as arrays, queues, containers, stacks, linear tables, pointers, linked lists, trees, graphs, structures, classes, heaps and hash tables.

Predefinition in the present disclosure may be understood as definition, predefinition, storage, prestorage, prenegotiation, preconfiguration, curing, or prefiring.

As used herein, the term “processor” may refer to one processor that performs the defined functions or a plurality of processors that collectively perform defined functions, such that the execution of the individual defined functions may be divided amongst such processors.

Those of ordinary skill in the art may understand that the units and algorithm steps of the instances described in connection with the embodiments disclosed may be implemented by electronic hardware, or a combination of computer software and electronic hardware. Whether the functions are executed by hardware or software depends on specific applications and design constraints of the technical solution. Professionals may use different methods to implement the described functions for each specific application, but such implementation should not be considered to fall beyond the scope of the present disclosure.

Those skilled in the art may clearly understand that, for the convenience and conciseness of description, reference may be made to a corresponding procedure in the method embodiment for a specific operation procedure of the system, device and unit described, which will not be repeated.

What are described are merely specific implementations of the present disclosure, and are not intended to limit the protection scope of the present disclosure. Any changes or substitutions that may be easily made by those skilled in the art within the technical scope disclosed in the present disclosure should fall within the protection scope of the present disclosure. Thus, the protection scope of the present disclosure should be subject to the protection scope of the claims.

1. A method for sidelink communication, performed by a terminal, the method comprising:
determining whether a listen-before-talk (LBT) fails for a sidelink (SL) transmission unit transmitted by the terminal; and
managing, in a case where the SL transmission unit comprises a report, the report based on a determination result.

2. The method according to claim 1, wherein managing the report based on the determination result comprises in a case where the LBT fails for the SL transmission unit, not cancelling the report, not stopping a timer associated with the report, regenerating the report, and transmitting the regenerated report during the operation of the timer associated with the report.

3. The method according to claim 2, wherein regenerating the report, and transmitting the regenerated report during the operation of the timer associated with the report comprises:
in a case where the terminal has an SL resource for additional transmission and the SL resource is capable of transmitting the report, regenerating the report, and transmitting the regenerated report through the SL resource during the operation of the timer associated with the report.

4. The method according to claim 2, wherein regenerating the report comprises:
autonomously determining, by the terminal, whether to regenerate the report based on implementation.

5. The method according to claim 1, wherein the report comprises at least one of:
a sidelink channel state information (SL CSI) report; or
a sidelink inter-user equipment coordination (SL IUC) report.

6. The method according to claim 5, wherein
in a case where the report is the SL CSI report, the SL transmission unit comprises a sidelink channel state information medium access control control element (SL CSI MAC CE), wherein the SL CSI MAC CE comprises the SL CSI report; and
in a case where the report is the SL IUC report, the SL transmission unit comprises a sidelink inter-user equipment coordination medium access control control element (SL IUC MAC CE), wherein the SL IUC MAC CE comprises the SL IUC report.

7. The method according to claim 1, wherein the method further comprises:
counting a number of transmissions of the SL transmission unit based on the determination result in a case where the SL transmission unit is transmitted on at least one of an SL grant configured by a network device or an SL grant autonomously selected by the terminal.

8. The method according to claim 7, wherein counting the number of transmissions of the SL transmission unit based on the determination result comprises:
not increasing the number of transmissions of the SL transmission unit by one in a case where the LBT fails for the SL transmission unit.

9. The method according to claim 1, wherein determining whether the LBT fails for the SL transmission unit transmitted by the terminal comprises:
determining that the LBT succeeds for the SL transmission unit in a case where the terminal does not receive an LBT failure indication.

10. The method according to claim 1, wherein the SL transmission unit is a sidelink medium access control protocol data unit (SL MAC PDU).

11. (canceled)

12. A terminal, wherein the terminal comprises one or more processors and a memory, and a computer program is stored in the memory, wherein the computer program stored in the memory, when executed by the one or more processors, causes the terminal to:
determine whether a listen-before-talk (LBT) fails for a sidelink (SL) transmission unit transmitted by the terminal; and
manage, in a case where the SL transmission unit comprises a report, the report based on a determination result.

13. A terminal, comprising one or more processors and an interface circuit, wherein
the interface circuit is configured to receive code instructions and transmit the code instructions to the one or more processors; and
the one or more processors are collectively configured to run the code instructions, to cause the terminal to:
determine whether a listen-before-talk (LBT) fails for a sidelink (SL) transmission unit transmitted by the terminal; and
manage, in a case where the SL transmission unit comprises a report, the report based on a determination result.

14. A non-transitory computer-readable storage medium, configured to store instructions, wherein the instructions, when executed by one or more processors of a terminal, cause the terminal to perform the method according to claim 1.

15. The method according to claim 1, wherein managing the report based on the determination result comprises:
in a case where the LBT fails for the SL transmission unit, not cancelling the report, not stopping a timer associated with the report, and retransmitting the SL transmission unit during operation of the timer associated with the report.

16. The method according to claim 1, wherein managing the report based on the determination result comprises:
in a case where the LBT succeeds for the SL transmission unit, cancelling the report, and stopping a timer associated with the report.

17. The method according to claim 1, wherein determining whether the LBT fails for the SL transmission unit transmitted by the terminal comprises:
determining that the LBT fails for the SL transmission unit in a case where the terminal receives an LBT failure indication.

18. The method according to claim 2, wherein regenerating the report comprises:
autonomously determining, by the terminal, whether to regenerate the report based on a triggering condition.

19. The terminal according to claim 12, wherein the terminal is further configured to:
in a case where the LBT fails for the SL transmission unit, not cancel the report, not stop a timer associated with the report, regenerate the report, and transmit the regenerated report during the operation of the timer associated with the report.

20. The terminal according to claim 12, wherein the terminal is further configured to:
in a case where the LBT fails for the SL transmission unit, not cancel the report, not stop a timer associated with the report, and retransmit the SL transmission unit during operation of the timer associated with the report.

21. The terminal according to claim 12, wherein the terminal is further configured to:
in a case where the LBT succeeds for the SL transmission unit, cancel the report, and stop a timer associated with the report.
